(19) United States
(12) Patent Application Publication
(10) Pub. No.: US 2024/0262761 A1
(43) Pub. Date: Aug. 8, 2024

(54) COMPOSTABLE SPUNBONDED TARP AND METHOD OF USING

(71) Applicant: 3M Innovative Properties Company, St. Paul, MN (US)

(72) Inventors: Ignatius A. Kadoma, Cottage Grove, MN (US); Megan K. Tuetken, St. Paul, MN (US)

(21) Appl. No.: 18/427,295

(22) Filed: Jan. 30, 2024

Related U.S. Application Data
(60) Provisional application No. 63/444,102, filed on Feb. 8, 2023.
(60) Provisional application No. 63/525,882, filed on Jul. 10, 2023.

(51) Int. Cl. C05F 11/02; B65F 1/00; B65F 1/14; D04H 1/435; D04H 1/56

(52) U.S. Cl. CPC C05F 11/02; B65F 1/0006; D04H 1/435; D04H 1/56; B65F 2001/1489; D10B 2331/041; D10B 2401/12

(57) ABSTRACT

A compostable container formed from a compostable, air-transmissive, spunbonded nonwoven fibrous web of meltspun fibers that are autogenously melt-bonded and that are additionally melt-bonded by point-bonds.

### CROSS REFERENCE TO RELATED APPLICATIONS

This application claims priority from U.S. Provisional Application Ser. No. 63/444,102, filed 8 Feb. 2023 and U.S. Provisional Application No. 63/525,882, filed 10 Jul. 2023, the disclosure of which is incorporated by reference in its/their entirety herein.

### BACKGROUND

Compostable materials such as yard waste, grass clippings, leaves, and the like, are often deposited into containers such as compostable paper bags, for transportation to a composting facility.

### SUMMARY

In broad summary, herein is disclosed a compostable container formed from a compostable, air-transmissive, spunbonded nonwoven fibrous web comprising meltspun fibers that are autogenously melt-bonded and that are additionally melt-bonded by point-bonds. In some embodiments the compostable container may be in the form of a tarp. These and other aspects will be apparent from the detailed description below. In no event, however, should this broad summary be construed to limit the claimable subject matter, whether such subject matter is presented in claims in the application as initially filed or in claims that are amended or otherwise presented in prosecution.

### BRIEF DESCRIPTION OF THE DRAWINGS

FIG. 1 is a top plan view of an exemplary tarp, in an unfolded condition.

FIG. 2 is an optical photomicrograph of an exemplary nonwoven fibrous web comprising autogenous bonds and also comprising point-bonds.

FIG. 3 is a Working Example photograph of an exemplary tarp in an unfolded condition with compostable material having been deposited on the tarp.

FIG. 4 is a Working Example photograph of an exemplary tarp with compostable material having been deposited thereon, and with first and second corners of the tarp having been brought together and tied into a knot.

FIG. 5 is a Working Example photograph of an exemplary tarp with compostable material having been deposited thereon, and with first and second corners of the tarp having been brought together and tied into a knot, and with third and fourth corners of the tarp having been brought together and tied into a knot.

FIG. 6 is an idealized, generic representation of an exemplary knot formed in diagonally-opposing corners of an exemplary tarp.

FIG. 7 is an isolated view showing an exemplary arrangement of a corner of an exemplary tarp.

FIG. 8 is a perspective view of an exemplary tarp in a folded condition.

FIG. 9 is a perspective view of two exemplary tarps each in a folded condition, with the folded tarps having been assembled into a stack for packaging.

Like reference numbers in the various figures indicate like elements. Some elements may be present in identical or equivalent multiples; in such cases only one or more representative elements may be designated by a reference number but it will be understood that such reference numbers apply to all such identical elements. Unless otherwise indicated, all figures and drawings in this document are not to scale and are chosen for the purpose of illustrating different embodiments of the invention. In particular the dimensions of the various components are depicted in illustrative terms only, and no relationship between the dimensions of the various components should be inferred from the drawings, unless so indicated.

Although terms such as “first” and “second” may be used in this disclosure, it should be understood that those terms are used in their relative sense only unless otherwise noted. As used herein as a modifier to a property or attribute, the term “generally”, unless otherwise specifically defined, means that the property or attribute would be readily recognizable by a person of ordinary skill but without requiring a high degree of approximation (e.g., within +/−20% for quantifiable properties). The term “substantially”, unless otherwise specifically defined, means to a high degree of approximation (e.g., within +/−10% for quantifiable properties). The term “essentially” means to a very high degree of approximation (e.g., within plus or minus 2% for quantifiable properties; it will be understood that the phrase “at least essentially” subsumes the specific case of an “exact” match. However, even an “exact” match, or any other characterization using terms such as e.g. same, equal, identical, uniform, constant, and the like, will be understood to be within the usual tolerances or measuring error applicable to the particular circumstance rather than requiring absolute precision or a perfect match. As used herein, terms such as “essentially free of”, and the like, do not preclude the presence of some extremely low, e.g. 0.2% or less, amount of material, as may occur e.g. when using large scale production equipment subject to customary cleaning procedures. The term “configured to” and like terms is at least as restrictive as the term “adapted to”, and requires actual design intention to perform the specified function rather than mere physical capability of performing such a function. All references herein to numerical parameters (dimensions, ratios, and so on) are understood to be calculable (unless otherwise noted) by the use of average values derived from a number of measurements of the parameter.

### DETAILED DESCRIPTION

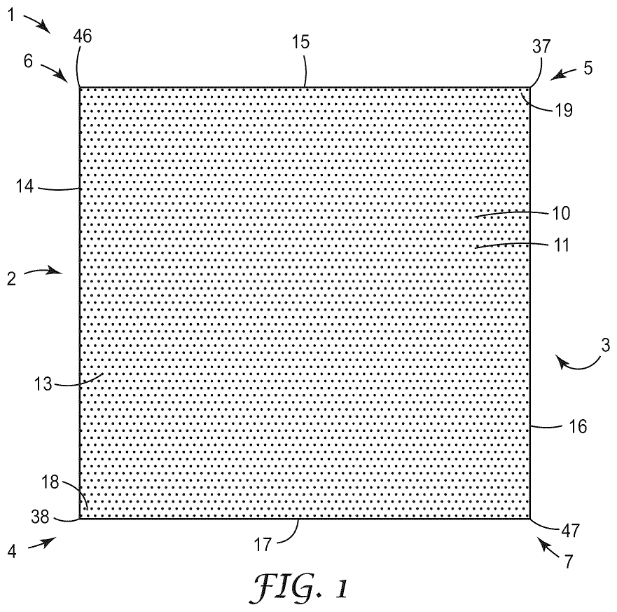

Disclosed herein is a nonwoven, spun-bonded web 10 that is compostable and that can be formed into a compostable container for gathering compostable material (e.g. yard waste, grass clippings and the like) and, e.g., for transporting the compostable material to a composting facility. The container itself being compostable, it can be entered into the composting stream along with its contents, rather than the contents having to be unloaded from the container. In some embodiments, such a container will be in the form of a tarp 1 as depicted in exemplary embodiment in FIG. 1. Tarp 1 (when unfolded to its maximum extent) is a generally sheet-like entity with a first major surface 2 and a second major surface 3. In the depicted embodiment, first major surface 2 is facing upward; however, in many embodiments tarp 1 will be reversible so that either major surface can face upward or downward with no change in the functioning of the tarp. Tarp 1 is compostable, meaning that it meets the requirements of ASTM Standard D6400-21. In many embodiments, tarp 1 is reversible, meaning that it can be used with either major surface (2 or 3) facing upward or downward.

As noted, such a container, e.g. a tarp 1, can be made from a spunbonded nonwoven web 10. The term “spunbonded” refers to a nonwoven web comprising a set of meltspun fibers that are collected as a fibrous mat and subjected to one or more bonding operations to bond at least some of the fibers together to transform the fibrous mat into a coherent web with sufficient mechanical integrity to be handled as a self-supporting layer; e.g., that can be handled with conventional roll-to-roll web-handling equipment.

The term “meltspun” refers to fibers that are formed by extruding filaments out of a set of orifices and allowing the filaments to cool and solidify to form fibers, with the filaments passing through an air space to cool the filaments and passing through an attenuation (i.e., drawing) unit to at least partially draw the filaments. Meltspinning can be distinguished from e.g. meltblowing in that meltblowing involves the extrusion of filaments into converging high velocity air streams introduced by way of air-blowing orifices located in close proximity to the extrusion orifices. Meltspun, spunbonded webs can also be distinguished from webs formed via air-laying processes (e.g. Rando-Webber processes), and from webs formed by carding, garnetting, cross-lapping, etc. Meltspun, spunbonded webs can also be distinguished from webs formed via wet-laying processes; in particular, from webs and sheets formed by conventional paper-making processes.

To perform melt-spinning, a thermoplastic fiber-forming material may be melted in an extruder and pumped into extrusion head. The extrusion head may be a conventional spinneret or spin pack, generally including multiple orifices arranged in a regular pattern, e.g., straightline rows. Molten filaments of the fiber-forming material are extruded from the extrusion head and pass through an air-filled space to an attenuator. In the air-filled space, one or more streams of air (e.g., quenching air) may be directed toward the extruded filaments to reduce the temperature of, and to at least partially or fully solidify, the extruded filaments to become fibers. The fibers are then passed through an attenuator to draw the fibers. An attenuator is configured to impinge rapidly-moving streams of air onto the fibers, which streams of air are moving at least generally in the same direction as the fibers during at least a portion of the fibers' trip through the attenuator. The moving air thus exerts a longitudinal shear force on the fibers, which shear force serves to draw the fibers, often to a substantial extent. The drawn fibers, after having passed through an attenuator, are then deposited onto a collector surface where they are collected as a mat of fibers. The collector surface may comprise e.g. a single, continuous collector surface such as provided by a continuous belt or a drum. The collector may be generally porous and a vacuum device may be positioned below the collector to assist in the deposition of fibers onto the collector.

The collected mat of meltspun fibers 11 will be subjected to a bonding process in which at least some fibers of the mat are melt-bonded to each other to transform the mat (which, as initially formed, may resemble “dryer lint” from a clothes dryer in having little or no mechanical integrity) into a coherent fiber web. In many embodiments, the melt-bonding will involve a thermal treatment (defined broadly herein as meaning exposure of the mat of meltspun, collected fibers to a temperature of at least about 80° C.).

In some embodiments the thermal bonding may include autogenous bonding, defined herein as melt-bonding of fibers 11 to each other at points of contact therebetween, with the bonding being performed without the application of solid contact pressure onto the mat. (Such a bonding method may thus be contrasted with e.g. calendering, ultrasonic bonding, and the like.) Autogenous bonding is fiber-fiber bonding that does not involve the use of added binder or adhesive or the like. Still further, autogenous bonding is distinguished from mechanical bonding methods (such as needle-punching, hydroentangling, and the like) that rely on fiber entanglement. Ordinary artisans will appreciate that autogenous bonding (in particular, through-air bonding as described below), will provide fiber-fiber melt-bonds that are readily distinguishable from bonds achieved by other means, e.g. by calendering or ultrasonic bonding, or by way of an added binder or by needle-punching or hydroentangling.

In particular embodiments, the autogenous bonding may take the form of through-air bonding, as achieved by passing a stream of heated air through the mat of collected fibers (i.e., impinging the heated air onto the mat so that the heated air enters through a first major face of the mat, passes through the thickness of the mat, and exits through a second, opposing major face of the mat, assisted if desired by a vacuum applied to the second major face of the mat). Exemplary through-air bonding apparatus and methods are discussed in detail in U.S. Patent Application Publication 2008/0038976 to Berrigan (which refers to some through-air bonders as quenched-flow heaters), which is incorporated by reference herein in its entirety. Further bonding apparatus and methods that may be suitable for the uses herein are described in detail in U.S. Pat. No. 9,976,771, which is incorporated by reference in its entirety herein.

Ordinary artisans will appreciate that thermal bonding (e.g., autogenous bonding, in particular through-air bonding) can be performed so as to melt-bond a sufficient number of fibers to each other to transform a meltspun fiber mat into a coherent, mechanically robust web (thus the web may be termed a spunbonded web 10), without heating and/or compressing the fibers 11 to the point that they collapse into a densified structure or otherwise unacceptably reducing the porosity of the thus-formed web.

It will thus be appreciated that autogenous bonding, e.g. through-air bonding, can melt-bond fibers to each other to form a self-supporting web without significantly compacting or densifying (e.g. crushing) the web. Autogenous bonding and the resulting bonds are thus distinguished from e.g. bonding performed by calendering, ultrasonic bonding, and like processes. Melt-spinning processes and/or the performing of autogenous bonding on meltspun fibers is discussed in further detail e.g. in U.S. Pat. Nos. 6,607,624, 6,916,752, and 8,162,153, all of which are incorporated by reference in their entirety herein.

In some embodiments, a spunbonded web 10 as achieved by at least some degree of autogenous melt-bonding, e.g. through-air bonding, may be subjected to an additional melt-bonding process. One such process is known as point-bonding. (Strictly speaking, the bonding may occur over discrete, individual areas that are each as large as e.g. one square mm. Nevertheless, the term point-bonding will be used for convenience of description herein.) Such point bonding is often performed using roll-based equipment, e.g. a calendering roll that has protrusions, and a backup roll. The web can be passed through a nip between the calendering roll and the backup roll (one or both of which may be heated to an appropriate temperature, with the rolls being pressed together at an appropriate pressure) so that in areas of the web that are contacted by the protrusions, the fibers are at least partially melted and bonded together.

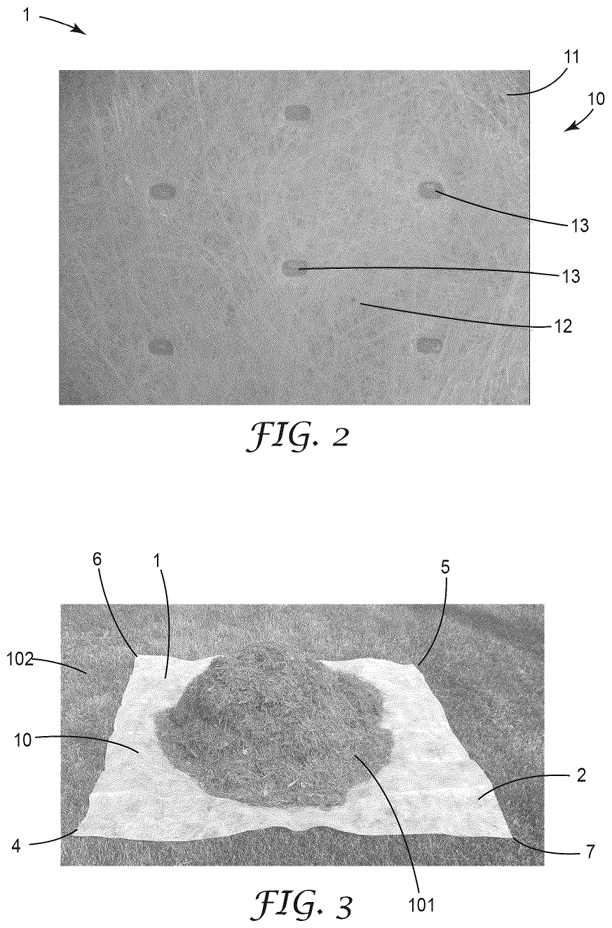

Exemplary point-bonds 13 as achieved by calendering are visible in the optical photograph of FIG. 2 (noting that FIG. 2 depicts a spunbonded web that was made for other purposes than disclosed herein but that nevertheless provides an excellent illustration of point-bonds 13). As is characteristic of such point-bonds, each point-bond 13 is seen to comprise numerous (e.g. ten or more) fiber segments that have been melted and consolidated together over a local area so as to substantially lose their individual character (appearance and shape) in the bonded area.

A spunbonded web 10 may include such point bonds 13 at any appropriate size and area coverage. In various embodiments, the point-bonds may be sized and spaced so as to occupy an area percentage of the total web that is greater than 2, 5, 8, 11, or 14%. In further embodiments, such point-bonds may be present at an area percentage of the web that is less than 25, 22, or 19%. In particular embodiments, the point-bonds may occupy from at least 15% to at most 20% of the total area of the web. The point-bonds may be present in any desired pattern (e.g. a square array, a hexagonal array as in FIG. 2, etc.) and the individual point-bonds may have any suitable shape (e.g. they may be generally rounded as in FIG. 2; or, they may be e.g. square, diamond-shaped, and so on).

The present work has revealed that choosing an appropriate level of point-bonding (as manifested in a particular area coverage of point-bonds as discussed above) can allow the mechanical integrity, e.g. the burst strength (as characterized according to methods outlined in ASTM Standard D3786M), of a spunbonded nonwoven web to be enhanced without adversely affecting other desirable properties (in particular, the transmissivity of the web to air and to water vapor, as discussed later herein).

A nonwoven fibrous web 10 for use as a compostable container, e.g. a tarp, may have any suitable basis weight. It has been found that spunbonded webs of compositions as generally disclosed herein, when processed to have autogenous bonds and point-bonds as discussed herein, may have optimum performance when their basis weight is from 20 to 100 grams per square meter. Thus in various embodiments, a nonwoven fibrous web 10 for use as disclosed herein may have a basis weight that ranges from at least 20, 25, 30, or 35, to at most 100, 80, 60, 50, or 40, grams per square meter.

In at least some embodiments, a nonwoven fibrous web 10 for use as a compostable container may be air-transmissive. This term is used in general to denote that the fibrous web comprises sufficient air-passages therethrough to allow air and other gases, and vapors such as water vapor, to pass through the web by flowing through these passages. This can be contrasted with materials (e.g. dense films, heavily densified fibrous webs, etc.) that primarily allow the passage of gases and vapors therethrough only by means of molecular diffusion. The air-transmissivity of a web 10 may be characterized by the use of an air-permeability densometer (such as those densometers available from Gurley Precision Instruments, Troy, NY), with which the time is measured for a specified volume of air to be passed under a specified force through a specified area of the substrate (as described e.g. in U.S. Pat. No. 6,858,290, which is incorporated by reference herein in its entirety for this purpose). By air-transmissive is meant that a sheet-like substrate (e.g. a nonwoven web, a tarp formed from such a web, etc.), when tested in the manner described in the '290 patent, exhibits a 50 cc Gurley densometer time of less than 15 seconds. In contrast, many low-air-transmissivity substrates (such as e.g. many compost bags made of kraft paper) will exhibit a 50 cc Gurley densometer time that is very long, e.g. hundreds of seconds or more. In various embodiments, a nonwoven web as disclosed herein may exhibit a 50 cc Gurley densometer time of less than 10, 5, 2, or 1 second. In further embodiments, a nonwoven web may exhibit a 50 cc densometer time of at least about 0.2, 0.5, 1.0, 2.0, or 4.0 seconds. In many embodiments, a herein-described fibrous web 10 (and, e.g., a tarp or bag made therefrom) may be so air-transmissive that the air-transmissivity is evident to even casual inspection, e.g. by blowing a gentle stream of air onto a major surface of the web and observing that a large amount of air flows through the web and emerges from the other major surface of the web.

In some embodiments, a nonwoven web 10 may be provided with perforations to enhance the air-transmissivity. By definition, a perforation is a through-hole that is formed by post-processing the spunbonded web (e.g. by die-cutting, laser-cutting, needling, etc.) rather than a through-passage that arises inherently in the forming of the spunbonded web. However, in some embodiments, nonwoven web 10 and a container made therefrom may achieve high air-transmissivity without any perforations being present. In other words, in some embodiments the melt-spinning process, the manner in which the fiber are collected and bonded, and so on (in particular, the percentage of the area of the web that is subjected to point-bonding) may be manipulated so that the fibers are arranged in a manner that allows the desired air-transmissivity.

In some embodiments a nonwoven web 10 may exhibit high porosity, e.g. in order to achieve the above-discussed air-transmissivity. (As alluded to above, in many embodiments such porosity may be present in the form of connected through-passages that permit airflow through the web rather than being e.g. in the form of non-connected cavities in the manner of a closed-cell foam.) Porosity may be conveniently characterized in terms of “loft” (and its converse “solidity”), as described in detail in U.S. Pat. No. 8,162,153, which is incorporated by reference herein in its entirety. In various embodiments, a nonwoven web 10 and/or a container obtained therefrom may exhibit a loft of at least 75, 80, or 85%. In further embodiments, web 10 may exhibit a loft of at most 95 or 90%.

In at least some embodiments, a nonwoven fibrous web 10 may be non-water-absorbent. By this is meant that the web, when tested in general accordance with the guidelines presented in ASTM Standard D570-98 (2018), will exhibit a water absorption of less than 0.8%. In various embodiments, the web may exhibit a water absorption of less than 0.6 or 0.4%. Such attributes may be contrasted with e.g. common cellulosic materials (e.g., unbleached kraft paper) as often used for compost bags and the like, which exhibit high water absorption and thus are more susceptible to becoming water-saturated and soggy to the point that they can begin to lose mechanical strength and integrity.

It is noted that in many embodiments, the processing of a compostable nonwoven web 10 to form it into a compostable container (e.g. a tarp or bag) will not cause major changes to the fundamental structure and inherent properties of the nonwoven web. Rather, such processing may often involve little more than cutting the nonwoven web to a particular size and shape (e.g. to form it into a tarp), forming one or more folds, gathers, joints and/or seams in the web (e.g. to form it into a bag), and operations of this general type. Any such processing will typically leave the majority of the area of the nonwoven web in its original, as-formed condition. This being the case, any property that is described herein in terms of being a property of the nonwoven web, will be understood to be applicable to a container that is formed from the nonwoven web.

### Tarp

In some embodiments, a compostable container as disclosed herein may be in the form of a tarp. Such a tarp, when in a ready-to-use condition, will be a substantially two-dimensional, sheet-like object. That is, a tarp 1 will not exhibit any stable three-dimensional shape prior to being loaded with compostable material (after the tarp is loaded with the compostable material, the tarp can be conformed into a three-dimensional shape to become a container for the compostable material, as discussed in detail later herein). Rather, a tarp 1 as disclosed herein, when unfolded into a ready-to-use condition, will be a generally flat and planar, sheet-like material. Tarp 1 will be flexible and pliable so that it will tend to conform to whatever surface (e.g. the ground) that the tarp is placed on. Thus in many uses, the tarp may not be strictly planar but rather will e.g. conform to undulations and irregularities in the ground on which the tarp is placed. (The ground is an example of a generally horizontal surface upon which a tarp 1 may be positioned for collection of compostable material; by a generally horizontal surface is meant one that has an overall slope of less than 30 degrees.)

A tarp 1 as disclosed herein may exhibit any suitable size. It has been found that a size ranging from about 15 square feet to about 50 square feet may be suitable. In various embodiments, the size may range from 25 square feet to 45 square feet. In particular embodiments, the size may range from 32 square feet to 40 square feet. It has been found that such size ranges offer a good combination of being able to hold a considerable amount of compostable material (e.g. yard waste) but without the amount being so large that the weight of the compostable material makes the loaded tarp unwieldy to carry by hand in the manner discussed later herein.

A tarp 1 as disclosed herein may exhibit any suitable shape. By this is meant a two-dimensional shape when the tarp is viewed along a direction normal to a major plane of the tarp (e.g., as viewed in FIG. 1). It has been found that a shape that provides at least three, and not more than six, distinguishable corners that can be formed into one or more handles as discussed in detail later herein, may be optimum. In some embodiments, a tarp 1 as disclosed herein may be at least generally square in shape; i.e. so that is has four corners (e.g. corners 4, 5, 6 and 7 as shown in FIG. 1). By at least generally square is meant that the tarp exhibits an aspect ratio of longest length to shortest length that is no greater than 1.2 (the shape may thus be slightly rectangular). By this is further meant that the tarp will exhibit four major edges that are present as two pairs of opposing, generally parallel edges (e.g., major edges 14 and 16, and major edges 15 and 17, as shown in FIG. 1). Each edge will extend between two neighboring corners of the tarp in an overall manner that is generally linear and not interrupted by any substantial outwardly-extending protrusions, inwardly-extending notches, etc., along the length of the major edge.

In some embodiments any such generally linear major edge of tarp 1 may be slightly curved, e.g. so as to exhibit a radius of curvature that is greater than 50 feet. In some embodiments any such generally linear major edge need not necessarily be strictly linear on a local or small scale. For example, the edge may be slightly undulating, zig-zag (e.g. as if cut with pinking shears), scalloped, or the like, on a local scale, as long as the overall at-least-generally-linear aspect of the edge in extending between its two corners is maintained. In some embodiments, any or all such major edges may be strictly linear, e.g. as with edges 14-17 as depicted in FIG. 1. In some embodiments tarp 1 may be at least substantially square, meaning that the above-described aspect ratio is no greater than 1.1. In some embodiments the tarp will be at least essentially square, meaning that the above-described aspect ratio is no greater than 1.05.

In some embodiments, one, some, or all of the major edges of tarp 1 (e.g. major edges 14-17 of an at least generally square tarp 1 as depicted in FIG. 1) may be unhemmed edges. A hemmed edge is one in which an elongate, terminal section that extends along the edge of the tarp is folded back on itself and bonded to form a hem comprising at least two layers of the tarp material (i.e., the nonwoven fibrous web). An unhemmed edge will not comprise any such arrangement (nor will any added supporting material, e.g. a reinforcing strip or the like, be present on an unhemmed edge).

In some embodiments, one or more major edges of a tarp 1 may be densified, meaning that heat and pressure are applied to an elongate, terminal section that extends along the edge of the tarp to consolidate the fibers in this section (e.g., in the general manner that fibers were consolidated to form point-bonds 13 as discussed earlier herein). However, the present investigations have revealed that the presence of autogenous bonds along with an appropriate level of point-bonds 13, throughout the tarp and in particular in areas that border its major edges, can eliminate any need for such edge-densification. That is, the combination of autogenous bonds and point-bonds have been found sufficient to prevent the major edges of the tarp from tearing, fraying, fuzzing, unraveling, or otherwise becoming functionally or aesthetically unacceptable.

Thus in some embodiments, some or all of the major edges of a tarp 1 as disclosed herein may be unfinished edges, meaning that the edges are not only unhemmed, but also have not been subjected to any densification or to any other post-processing to reinforce the edges. In other words, in embodiments in which the edges are unfinished, the edge areas of the tarp may have the exact same composition, fiber arrangement, and so on, as the interior portions of the tarp.

In some embodiments, a tarp 1 that relies on a nonwoven fibrous web 10 may take the form of a single layer; the single layer being the nonwoven web 10 itself. As such, a single-layer tarp 1 will not comprise two or more webs that are formed separately and are then laminated together to form the tarp. However, in some embodiments a nonwoven web, e.g. a meltspun/spunbonded web, may be formed by performing two (or more) successive melt-spinning depositions to form a fiber mat, after which the fiber mat is subjected to bonding. The resulting spunbonded web will be considered a single-layer web as defined herein. The requirement that a tarp 1 be a single layer, precludes the presence of any netting, scrim, reinforcing layer, or the like, that might be present in addition to the single layer of spunbonded nonwoven web.

In some embodiments a tarp 1 as formed from a nonwoven fibrous web 10 in the general manner disclosed herein will be unsupported. By this is meant the tarp as configured and provided for use in collecting compostable material and acting as a container for such material, is not held or supported by any kind of frame, cradle, gantry, support structure, or the like (in particular, any kind of structure that serves to hold the tarp in a three-dimensional shape, e.g. as an upwardly-open-ended receptacle). Rather, for use, the tarp will typically simply be laid flat on a surface (e.g. a generally horizontal surface such as the ground) as shown in FIG. 3; there is no support frame to hold the tarp in any other (e.g. non-planar) shape. Any tarp that is described as being used (e.g. by an end-user, to collect compostable material) in combination with any type of support frame or the like is thus not an unsupported tarp as defined herein. (This will be the case even if such a tarp is configured so that a support frame is supplied separately and is then mated to the tarp for use of the tarp.)

By unsupported is further meant that the herein-disclosed tarp does not have any kind of internal or external support member(s), brace(s), rod(s), and so on, that is/are connected to the tarp (whether at the factory or by the end-user, and whether removably or permanently). For example, an unsupported tarp will not have any strut, beam, or the like, that extends e.g. along a perimeter edge of the tarp, across a portion of the interior of the tarp, from a geometric center of the tarp toward an edge and/or corner of the tarp, and so on. This is the case regardless of whether such a member, brace, rod, strut or beam etc. is e.g. permanently attached to the tarp or merely that the ends of the strut or beam are e.g. removably inserted into pockets provided in the tarp.

In some embodiments an unsupported tarp may comprise one or more seams in which the material of the tarp has been e.g. folded and joined to itself to form an inherent stiffening element. In various embodiments, any such seam may e.g. extend the length or width of the tarp (noting that the length and width may be indistinguishable in the case of a strictly square tarp), may extend diagonally across the tarp, etc. While in some embodiments it may be helpful to have one or more such seams e.g. to reinforce the tarp, the present investigations have revealed that so far, there seems to be no need for any such arrangement in a tarp. Thus in some embodiments, an unsupported tarp 1 will not comprise any hems, seams, or the like, in which material of the tarp has been e.g. folded and joined to itself to form an inherent stiffening element.

In some embodiments a tarp 1 may not comprise any separately-made items (e.g. joining structures such as hook-and-loop fasteners as discussed below, or the like) that are attached to the tarp. Thus in some embodiments, a tarp 1 as disclosed herein may consist essentially of the nonwoven fibrous web 10 from which the tarp is obtained. The terminology of “consist essentially” allows the presence of ancillary items such as e.g. a label denoting information about the tarp, a layer of adhesive by which such a label may be (permanently or removably) mounted on the tarp, and items of a similar nature, that do not affect the mechanical strength or the nature of functioning of the tarp. Such terminology does however preclude the presence of e.g. one or more cords, drawstrings, grommets, eyelets, straps, handles, closures, clips, snaps, pockets, stitchings, and so on, that are non-integral with the fibrous web but rather are made separately and are attached to the web or otherwise provided with the web and are used with the web in its functioning as a tarp. In short, such terminology precludes the presence of any entity that is separately made and then attached to the tarp, with the exception of items such as labels, indicia (e.g. printed indicia), and the like that do not affect the nature of functioning of the tarp. Any such entity (e.g. a label) that is present, if it is not removable e.g. at the time of use of the tarp, should of course be compostable.

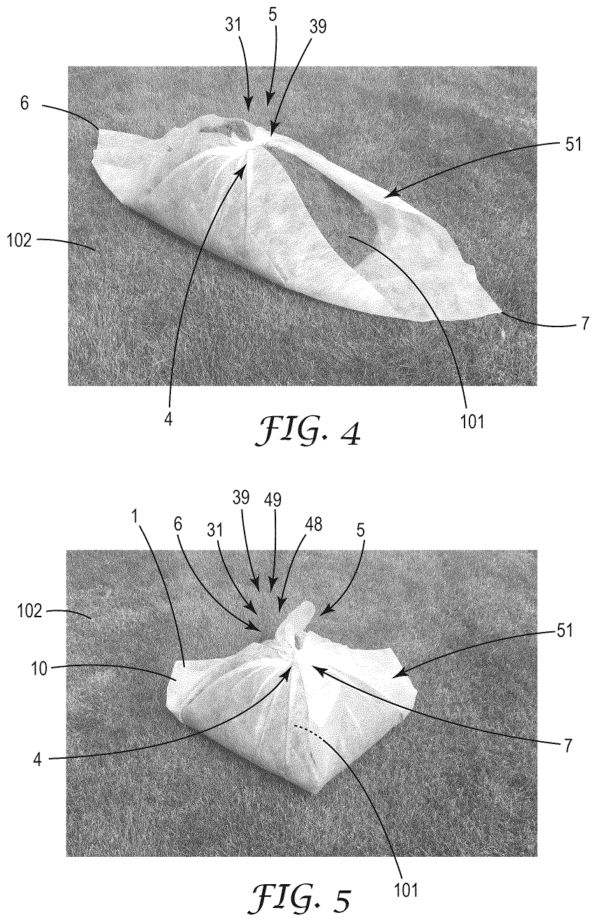

A compostable container such as a tarp 1 may be used for collection and transport of compostable material, e.g. yard waste. For example, as evident from the Working Example photograph shown in FIG. 3, tarp 1 may be positioned on a generally horizontal surface 102 (most conveniently, on the ground) in a fully unfolded condition. A compostable material 101 such as e.g. yard waste (grass clippings, in the depicted embodiment of FIG. 3) may be deposited onto the upper surface of the tarp. First and second diagonally-opposing corners 4 and 5 of tarp 1 may then be brought together and collectively formed into a handle 39 in the general manner shown in FIG. 4. Such a handle 39 can allows the tarp, as loaded with compostable material 101, to be transported, e.g. hand-carried, to a pick-up location such as a curbside pick-up location. In some embodiments, third and fourth diagonally-opposing corners 6 and 7 of the tarp may similarly be brought together and collectively formed into a second handle 49 as shown in FIG. 5. In some such embodiments, handles 39 and 49 can both be grasped for use in carrying the loaded tarp.

While an arrangement of the general type shown in FIG. 5 may enhance the ability to carry the loaded tarp while minimizing any potential spillage of the compostable material 101 held therein, it is emphasized that for some uses, a single handle 39, providing an arrangement of the type shown in FIG. 4, may be sufficient. (In fact, in some embodiments it may be preferable, e.g. if the compostable material 101 comprises a significant number of elongated items such as twigs and small branches.)

Two diagonally-opposing corners of tarp 1 may be joined together to form a handle in any suitable manner. In some embodiments, complementary joining structures 18 and 19 (indicated in generic representation in FIG. 1) may be provided on two diagonally-opposing corners of the tarp to allow the corners to be joined together. Such joining structures may comprise e.g. hook and loop fasteners, e.g. with structure 18 bearing hooks and structure 19 bearing loops. If any such joining structures are present, they must be compostable (and must be attached to tarp 1 in way that preserves compostability) so that tarp 1 as a whole, including the joining structures, is compostable.

Another possibility is that a separately-provided compostable joining structure, e.g. in the form of a clip or the like, may be used. Such a clip may be a compostable clip that resembles the items commonly referred to as compostable trellis clips, vine-clips, tomato clips, etc. In such a case, two (or more) corners of tarp 1 may be brought together and gathered into a compressed configuration, after which the compostable clip may be clipped onto the gathered corners to hold them in this configuration.

While corner-joining arrangements of the general type outlined above are possible (and are encompassed within the present disclosures), they involve the necessity to have compostable joining structures attached to tarp 1 at the factory and/or the necessity for the end-user to keep track of, and use, separately-provided compostable items such as clips. The present investigations have revealed that it is possible, indeed preferable, to bring diagonally-opposing corners of tarp 1 together and to hold them together, without using any such items.

Thus in some embodiments, first and second diagonally-opposing corners 4 and 5 of tarp 1 may then be brought together and formed into a knot 31 that holds the corners together and serves as an integral carrying handle 39, as shown in FIG. 4. By a handle being “integral” is meant that each of the entities (i.e. corners) that combine to form the handle is an integral portion of tarp 1 (and thus of nonwoven web 10) rather than being an entity that is made separately and then attached or connected to tarp 1. In some embodiments, third and fourth diagonally-opposing corners 6 and 7 of the tarp may similarly be brought together and collectively formed into a second knot 48 that serves as a second integral carrying handle 49, which is the exemplary configuration shown in FIG. 5. In such embodiments, either or both of integral handles 39 and 49 can be grasped for use in carrying the loaded tarp. While an arrangement of the type shown in FIG. 5 may enhance the ability to carry the loaded tarp while minimizing any potential spillage of the compostable material 101 held therein, it is emphasized that for some uses, a single knot 31, providing a single handle 39 (thus providing an arrangement of the general type shown in FIG. 4), may be sufficient.

By a knot is meant an arrangement in which two (or more) corners of tarp 1 are brought together and are routed, positioned and arranged to be bodily entangled, entwined, etc., with each other, so that they tend to resist separating into their component corners. In many embodiments, the material of the corners of tarp 1 may be “gathered” to facilitate this. By gathered is meant that at a corner, the material of tarp 1 is manually manipulated so as to transform from a generally planar shape to a shape that is compressed (and is e.g. wrinkled, crumpled, accordionized, twisted, or the like). The gathering process will cause the corner of the tarp to converge into a relatively narrow length of material that is elongated generally along an axis directed toward the very tip of the corner and that can be manipulated to form a knot. Such an arrangement is depicted in exemplary, idealized representation in FIG. 6, in which corners 4 and 5 have been gathered (as illustrated by the “wrinkling” lines 44 shown in FIG. 6) into elongate lengths that respectively terminate at tips 38 and 37.

A knot as used for the purposes disclosed herein can embrace any arrangement, including those that are not necessarily favored for other (e.g. more demanding) uses. FIG. 6 illustrates, in idealized representation, diagonally-opposing corners 4 and 5 that have been brought together, gathered, and manipulated to form a knot 31, which in this case is a single overhand knot. In this single overhand knot, the gathered corners 4 and 5 have been routed so as to cross over each other at three points 32, 33 and 34. If desired, the gathered corners can be further manipulated so that the single overhand knot exhibits additional crossover points (artisans in the field of knot-tying will recognize this as corresponding to an initial step in forming a so-called surgeon's knot).

While in some embodiments additional manipulations can be performed (e.g. to form a double overhand knot as discussed below), in some embodiments a single overhand knot may be sufficient. That is, the properties and attributes of certain nonwoven fibrous webs 10 that can be used as a compostable tarp 1, in particular their frictional properties, are such that two such tarp-corners that are gathered and formed into a single overhand knot of the general type depicted in FIG. 6, may resist separating into their component corners. Thus in such embodiments, a single overhand knot may serve to hold the corners together, to provide an adequate carrying handle 39, and so on, in the general manner discussed above.

However, in some embodiments, it may be preferred to perform additional manipulations. One such option is to further manipulate the end sections 35 and 36 of gathered corners 4 and 5 to form an additional single overhand knot, with the first and second single overhand knots collectively forming a double overhand knot. A double overhand knot is exemplified by the well-known knot commonly known as a square knot or a reef knot. The present investigations have found that with the herein-disclosed nonwoven webs and tarps made therefrom, the tarp corners can be easily gathered to a sufficient extent to provide an elongate length of gathered material that is ample to allow the manipulations needed to form a double overhand knot.

As noted above, for the uses disclosed herein (e.g. the carrying of a loaded tarp to a pick-up point), a knot is not necessarily limited to those knots that are qualified for other, more demanding uses. Thus for example, while the use of a knot such as a granny knot, a thief knot, a grief knot, and the like, may be anathema to those who are concerned e.g. with safety lines in rock-climbing or the like, they can be adequate for the uses outlined herein. In other words, a homeowner who is collecting grass clippings may find a casually-tied granny knot to be adequate as long as it holds together sufficiently to allow the loaded tarp to be hand-carried to a collection point and e.g. collected by a municipal yard-waste hauling vehicle.

In summary, the type of knot that is used is of no consequence as long as it meets the minimum standards outlined herein. Thus, any knot that falls into the general category of a “bend” (meaning a knot that is used to join two entities together) may be used. These include, but are not limited to, a fisherman's knot, a surgeon's knot, a water knot, a grass knot, a sheet bend, a Hunter's bend, and a Carrick bend. One approach that may be particularly convenient is to bring the two gathered corners together so that they are aligned with each other and to then tie an overhand knot in them as if they were a single entity, to form a so-called offset overhand bend.

Any such (first) knot 31 may be formed between a first pair of diagonally-opposing corners (e.g. corners 4 and 5). As mentioned above, a second knot 48 may likewise be formed between a second pair of diagonally-opposing corners (e.g. corners 6 and 7). The second knot may or may not be of the same type as the first knot. The second knot may be tied independently of (but usually located relatively close to) the first knot; or, the second knot may be tied onto the first knot. Any such arrangements are within the scope of the disclosures herein.

It is thus summarized that in some embodiments, a pair of diagonally-opposing corners (and optionally a second pair of diagonally-opposing corners) may be brought together, gathered, and formed into a knot, so as to a transform tarp 1 into a handle-bearing container 51 that can be used to hold and transport compostable material. The term container is used broadly (e.g. a tarp 1 as configured in FIG. 4 is considered to be a container) to encompass any tarp in which at least two corners have been brought together and held together, whether by knotting or e.g. by the use of a clip as discussed earlier herein. It is noted that although the use of knots may be particularly convenient (e.g. for homeowners) in not requiring any separately-provided clips, equipment or the like, in some cases, external equipment or devices may be used. Thus for example, particularly in the case of high-volume or mechanized processing of compostable material such as performed by yard-service companies and/or at golf courses, sod farms and the like, an apparatus such as e.g. a portable heat-sealer may be used to quickly join corners of a tarp together.

In some situations (e.g. when the compostable material includes a significant fraction of dry, bulky leaves) it may be advantageous to compress an initially-loaded batch of compostable material within the thus-formed container so that more compostable material can be added. In such a case, at least first and second diagonally-opposing corners of the tarp can be brought together (it may be convenient to bring all four corners together). The corners can be temporarily held together, or they may be temporarily tied together e.g. in a single overhand knot as described above, and pressure can then be applied to the outside of the tarp to compress the compostable material into a more densified mass. (In some situations, the edges and/or corners of the tarp may simply be folded over the contents and pressure applied to the tarp.) The tarp can then be returned to a flat condition (with any temporarily-tied knots being untied to allow this, if need be) and more compostable material can be added.

In at least some embodiments, the present arrangements allow a nonwoven fibrous web 10 to be formed e.g. into an at least generally square tarp 1. This may start with forming the web on a continuous basis via meltspinning and bonding processes as described earlier herein, at a desired crossweb width (e.g. six feet). The continuous web may then be cut into desired lengths (e.g. six feet), so as to provide tarps that are e.g. six foot by six foot in size. A significant advantage of such arrangements is that they can allow a nonwoven web to be formed into tarps in this manner, while necessitating the removal of little or no web as wastage (such cut-away web material is often referred to as “weed”).

It will be appreciated that if a tarp includes one or more handles that protrude significantly outward beyond the major edges of the tarp (including at the corners), such handles may have to be made separately and then attached to the tarp. Alternatively, if the handles are integral with the tarp, there may be an enormous amount of wasted web in the form of weed that must be cut away from the perimeter areas of the tarp to leave the integral handles behind.

Such considerations can be at least semi-quantitatively assessed by way of a web-usage efficiency factor. Such a factor can be obtained by identifying points that are integral to the tarp and that are farthest from the geometric center of the tarp and drawing a convex polygon that, using the fewest straight-line segments possible, connects the points and circumscribes the tarp (so that no portion of the tarp lies outside the polygon). The actual area of the tarp can be ratioed to the area of the thus-drawn polygon to provide the web-usage efficiency factor, which can be expressed as a percentage.

For a web of the type exemplified in FIG. 1, such a polygon will be drawn as a square that connects points 46, 37, 47 and 38. It will be appreciated that in such a case, the web-usage efficiency factor will approach 100%. Other arrangements (e.g. as depicted in FIGS. 1 and 2 of Canadian Patent Application 3037914) may exhibit a far lower web-usage efficiency factor (e.g., in the range of 60-70%).

It will be appreciated that achieving a high web-usage efficiency factor (e.g. greater than 85, 90, 95, or even 98%) can be significantly advantageous. Many compostable fiber-forming thermoplastic materials (e.g., poly lactic acid) can exhibit significant challenges when attempting to recycle weed back into an extrusion process. For example, the weed may need to be extensively re-dried and/or re-crystallized in order to be used successfully in subsequent extrusion. Thus, the efficiency with which a given amount of nonwoven web is transformed into a usable tarp can be a key factor in commercial success or failure.

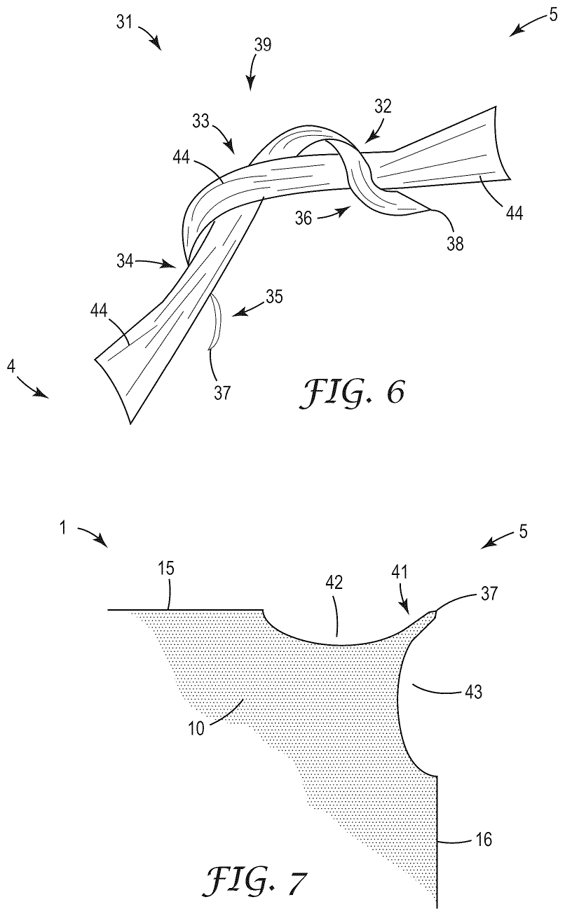

The herein-disclosed arrangements can achieve high efficiency of web usage, particularly if a tarp is made in the general manner described above, e.g. in an at least generally square shape with the size of the tarp substantially corresponding to the crossweb width of the nonwoven web as made. However, in some embodiments, arrangements may be made which may enhance the functioning of the tarp while preserving the above-discussed advantages. For example, FIG. 7 depicts, in generic, exemplary representation, a corner 5 of a tarp from which some material has been locally removed (e.g. by die-cutting) in areas 42 and 43. Such local removal of corner material can cause the corner 5 of the tarp to be present as a somewhat elongated length of material 41. This elongate length of material 41 may be easy to form into a knot (e.g., less of the above-described “gathering” may be needed). Similar arrangements may be provided at all corners of a tarp 1, if desired. It is evident from FIG. 7 that such an arrangement requires only that a relatively small amount of web material be removed as weed, in local areas 42 and 43, rather than requiring large-scale removal of weed along much of the length of the major sides of the nonwoven web. Such an arrangement may thus still achieve a web-usage efficiency factor of at least e.g. 85 or 90%. Such arrangements also typically will not reduce the carrying capacity of the resulting tarp significantly from that which would have been obtained if the corner material had not been locally removed. It is envisioned that in such arrangements, it may only be necessary to remove material as weed from a local area that is e.g. within 1.0 or 0.5 feet from the very tip of the corner. (Comparison of FIG. 7 with FIG. 1 makes these arrangements, and how to achieve them, readily apparent.) The material may be removed in any suitable shape, e.g. in a somewhat arcuate or semi-circular shape as in the exemplary illustration in FIG. 7.

Such arrangements can be recognized and identified by virtue of the fact that the very tip 37 of elongate length 41 of corner 5 remains at, or within, an overall perimeter obtained by extending imaginary lines along tarp major edges 15 and 16 toward corner 5, as is evident from FIG. 7. Such arrangements will be referred to herein as providing a tarp with integral elongated corners. It is emphasized that in such embodiments, the material of any such integral elongated corner will be integral with the tarp (and with the nonwoven web from which the tarp was obtained). That is, such arrangements are distinguished from those in which a separately-made handle, ribbon, strap, cord, etc., is attached to a corner of a tarp.

As noted, a tarp 1 as used herein may be used to collect compostable material e.g. by placing the tarp on the ground and depositing grass clippings, leaves, or materials of that nature, onto the tarp. The fact that a herein-disclosed tarp can be laid more or less flat on the ground for use (rather than having to sit upright), in combination with the above-discussed frictional characteristics of the nonwoven web, means that such a tarp may be easy to use on ground that is e.g. sloping, hilly, undulating, and so on. When a sufficient amount of material has been collected, some or all corners of the tarp may be joined together (e.g. by tying) so that the tarp serves as a handle-equipped container for the compostable material. The container can then be taken to a collection point (e.g. a curbside collection spot) e.g. by carrying the container by the handle. A collection vehicle (e.g. a municipal vehicle) may then collect the container, which may e.g. be deposited into the vehicle as a whole. In other embodiments, a homeowner (or yard service, or the like) may transport the container to a composting facility, at which the container and its contents can be entered into the stream of compostable material to be introduced into a composting batch. In other embodiments, a homeowner may deposit the container and its contents into their own, local (e.g. backyard) composting “facility”. This may all be done with the container and its contents being handled collectively, as a whole. That is, the arrangements disclosed herein do not necessitate manipulating the container to empty its contents into a compostable stream of material while retaining the container for subsequent use (although this could be done if desired).

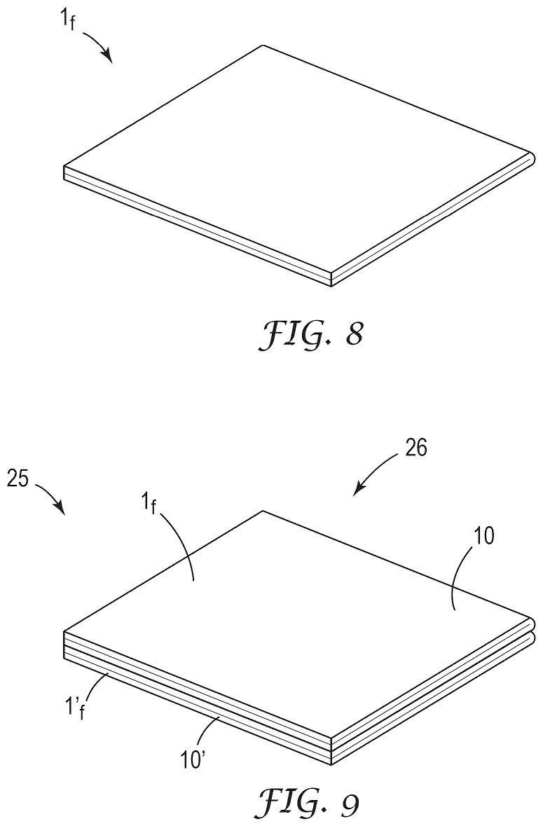

A suitable size for a tarp 1 as disclosed herein, in view of its end-use in collecting compostable material, may be in the range of e.g. six foot by six foot. Such a size being inconvenient for shipping, storage, inventory, display for sale, and so on, in some embodiments a tarp 1 may be folded (e.g., at the factory) for packaging, shipping, etc. An end-user may then unfold the tarp to its fully unfolded condition for use. Thus in some embodiments a tarp 1 may be packaged in a folded condition in which it exhibits a size that is less than 10% of the total area of the tarp when unfolded, as illustrated in exemplary embodiment in FIG. 8 (in which the folded tarp 1 is designated by reference number 1_{f}). Any suitable folding scheme may be used, whether involving successive half-foldings, z-folding, and so on. It will be appreciated that the absence of any separately-made items that are attached to the tarp (e.g. handles, cords, clips, fasteners, and so on), can allow the tarp to be folded very flat, without any non-uniformities or bulky regions or the like.

In some embodiments, multiple folded tarps 1_{f} may be packaged together, e.g. as a kit in a common package (the term package broadly encompasses relatively hard-sided containers such as cardboard boxes or cartons as well as compliant wrappings of e.g. cellophane and other films). In some convenient embodiments, multiple folded tarps may be packaged in a kit 25 as a stack 26 of folded tarps in the general manner depicted in FIG. 9 (only two folded tarps 1_{f} and 1_{f}′ are shown in this FIG. 9, but any number of folded tarps may be included). An end user may then remove folded tarps from the package as needed. In some embodiments, a package in which the folded tarps are provided, may itself be compostable. In such cases, when the last tarp is removed from the package, the package itself may simply be deposited into the tarp along with the other compostable material that is being collected. Of course, in various embodiments, other arrangements may be used. For example, multiple folded tarps may be rolled up together into a roll from which individual folded tarps may be extracted, rather than the folded tarps being stacked.

The arrangements disclosed herein rely on the use of a compostable nonwoven fibrous web 10 to form a compostable container for compostable material. By using a combination of autogenous bonding and point-bonding, the nonwoven web may be made very strong. In fact, the present investigations have found that due at least in part to the high amount of drawing that meltspun fibers can be subjected to, nonwoven webs made of e.g. polylactic acid can be significantly stronger (e.g. in terms of burst strength) than dense films made of the same polylactic acid, at comparable basis weights. Furthermore, the use of autogenous bonding and point-bonding in combination as disclosed herein can achieve this high strength while leaving much of the web (i.e., areas 12 of the web that are between discrete point-bonds 13 as indicated in FIG. 2) with a highly fibrous exposed surface as evident from FIG. 2. It has been found that this highly fibrous exposed surface increases the coefficient of friction of the surface of a tarp so as to allow the tarp corners to be tied into a knot, without the knot exhibiting a pronounced tendency toward coming undone as might occur with e.g. a more slippery or low-friction substrate (e.g. a film).

Furthermore, in many embodiments a nonwoven fibrous web as disclosed herein, and thus a container obtained from such a web, may exhibit high air-transmissivity in comparison to conventional yard-waste bags made from kraft paper and yard-waste bags made of dense films of polylactic acid or some other biobased polymeric material, as mentioned earlier. In particular, the use of meltspun fibers that are autogenously bonded over the entirety of the web area, along with point-bonds that occupy a chosen percentage of the area of the web, can allow the web to have high strength while preserving the high air-transmissivity of the web. This can provide for rapid passage of gases and vapors through the tarp, which can allow more rapid drying, minimization of odors, and so on.

In particular, such arrangements can allow water vapor to escape, which can provide key advantages. A somewhat underappreciated aspect of dealing with compostable materials is the amount of water that is often in such materials. For example, freshly cut grass clippings often contain up to about 80% by weight water. To haul containers of grass clippings to a centralized (e.g. municipal) composting facility thus can involve transporting a very large amount of water. The present investigations have revealed that the use of a nonwoven fibrous web with high air-transmissivity in the manner disclosed herein can provide a compostable container that allows rapid escape of water from its contents (e.g. from freshly-cut grass). As discussed in the Working Examples herein, the present investigations have found that highly air-transmissive nonwoven web-based compostable containers (bags, in the case of the Working Examples) allowed up to 20% water-weight loss within two days, and up to 35-55% water-weight loss within nine days, of the bagging of freshly-cut grass clippings. In contrast, Comparative Example compostable containers (again, bags) made of dense films of compostable polymers exhibited around 5% or less water-weight loss within two days, and around 5-15% water-weight loss within nine days.

It can thus be appreciated that since municipal yard-waste collections often run on a weekly or fortnightly schedule, a compostable container as disclosed herein can provide that (on average), by the time compostable containers of the type disclosed herein are picked up by a collection vehicle, they may have lost a considerable portion of their water, and thus their weight. This is obviously advantageous in terms of the cost to transport the yard waste to a centralized composting facility.

It is attested that a container that achieves a uniquely advantageous combination of compostability, high bursting strength, and high gas-and-vapor-transmissivity, and that is thus suitable in particular for the collecting and/or transporting of compostable materials such as e.g. yard waste, has not been previously presented in the prior art. It is further attested that the finding that a spunbond nonwoven web that comprises a combination of autogenous bonding and point-bonding of a selected area percentage, can achieve such a combination of advantageous properties, is unexpected based on known prior art.

Still further, in many embodiments a nonwoven fibrous web as disclosed herein, and thus a container obtained from such a web, may be noticeably translucent (as opposed to opaque, as with unbleached kraft paper bags) as is evident e.g. from FIGS. 4 and 5. This can allow at least some inspection of loaded tarps or bags to ascertain whether any extraneous items were inadvertently included with the compostable material.

Still further, in at least some embodiments a nonwoven fibrous web and the resulting container may be made of materials that are non-cellulosic, e.g. that are far less hydrophilic than the cellulosic materials that are commonly used for paper bags. So, a container as disclosed herein may be much less susceptible to absorbing water from the compostable material (which, e.g. in the form of grass clippings, leaves, etc., often has large amounts of water) to the point that the structural integrity of the container may suffer in the manner that sometimes happens with paper yard-waste bags. In fact, the performing of tensile and tear testing on Working Example webs in wet and dry conditions has indicated that the webs do not exhibit a drastic drop-off in strength when water-wetted, in contrast to conventional compostable cellulosic materials used e.g. for yard waste bags.

Discussions so far herein have primarily focused on using a compostable nonwoven fibrous web 10 in the form of a tarp 1. However, in general, a compostable nonwoven web 10 as disclosed herein may be formed into a compostable container of any type, configuration, geometric shape, and so on. The term container is thus not limited to tarps. For example, in some embodiments a compostable nonwoven web may be formed into a bag (e.g. a yard-waste bag), e.g. by folding two sections of the web together to form a two-layer stack, and then bonding along some edges of the stack (e.g. by ultrasonic bonding, heated-platen bonding, or any other suitable bonding method) while leaving at least one edge of the stack unbonded to serve as an opening for the bag. It will be appreciated that there are numerous possible variations of such arrangements. For example, multiple folds, gathers, seams, or the like, may be included so that the thus-formed bag exhibits a three-dimensional shape when fully opened. In this regard, a bag can be differentiated from a tarp even though both may be relatively flat e.g. when folded for packaging. A bag, when unfolded and opened to its maximum extent, will typically at least partially define an interior volume, whereas a tarp, when unfolded and opened to its maximum extent, will remain sheetlike (although it may assume the contours of whatever surface it is lying atop).

While discussions herein have primarily concerned yard waste, the spunbonded nonwoven webs disclosed herein may be used to form compostable containers for any compostable material, regardless of the size and/or shape of the container or the particular compostable material that is envisioned to be disposed into the container. Thus in various embodiments, a nonwoven web as disclosed herein may be formed into e.g. a trash can liner bag (e.g., for kitchen or food waste in particular), a pet-waste (e.g. doggie-doo) bag, and so on. Not all uses are necessarily for waste; for example, a nonwoven web as disclosed herein may be formed into a compostable produce bag or a compostable general-purpose shopping bag. In fact, a nonwoven web as disclosed herein may find use in some non-container applications e.g. in which a combination of compostability (or, biodegradability in general), high burst strength, and high gas-and-vapor transmission is advantageous. Such uses (which may include e.g. geotextiles, landscaping fabrics and the like) are within the scope of the present disclosures.

### Compostable Materials

A container (e.g. a tarp or bag) and the nonwoven fibrous web 10 from which the container is obtained, will be compostable as defined earlier herein. In some embodiments, the nonwoven web 10 will be biobased, meaning that at least 90 wt. % of the materials of the web are derived from plant-based sources rather than from feedstocks based on petroleum, natural gas, or coal. In further embodiments, at least 95, 97, or 99 wt. % of the materials will be derived from plant-based sources.

In various embodiments, a nonwoven fibrous web 10 from which a compostable container is obtained, may comprise, or consist essentially of, materials chosen from e.g. polylactic acid, polybutylene succinate, polybutylene adipate terephthalate, polycaprolactone, polyhydroxyalkanoate, poly-3-hydroxybutyrate, polyhydroxyvalerate, and polyhydroxyhexanoate. In some embodiments, zein-based materials and/or cellulosic esters may be present. In various embodiments, mixtures, blends, copolymers, and so on, of any of the above-listed materials, in any combination, may be used.

In some embodiments, nonwoven fibrous web 10 may include, e.g. consist or consist essentially of, fibers that comprise, consist, or consist essentially of polylactic acid polymers. A polylactic acid polymer (noting that the term polymer is considered to include copolymers) will include lactic acid monomer (repeat) units. In various embodiments, web 10 may be comprised of greater than 95, 98, or 99% by weight of fibers that, in turn are comprised of greater than 95, 98, or 99% by weight of lactic acid monomer repeat units. Such fibers and/or webs can be contrasted with fibers and/or webs that contain polylactic acid in combination with materials such as processed starches, vegetable oils, plasticizers, cellulosic and/or cellulose acetate materials, reactive-compatibilized monomers, reinforcing fillers, and so on. Such additives may improve certain properties of the materials but may have deleterious effects in other aspects. In contrast, the present investigations have revealed that in some embodiments, nonwoven webs that consist at least essentially of polylactic acid polymer materials may be used. Such arrangements can e.g. achieve maximal production efficiency at minimum cost and can also make maximal use of the compostability of polylactic acid.

Such polymers or copolymers may generally be derived from monomers chosen from any isomer of lactic acid, such as L-lactic acid, D-lactic acid, or mixtures thereof. Polylactic acid may also be formed from anhydrides of any isomer of lactic acid, including L-lactide, D-lactide, meso-lactide, or mixtures thereof. Cyclic dimers of such lactic acids and/or lactides may also be employed. Thus, for example, an L-lactic acid monomer unit of a polylactic acid will be understood as being derivable from an L-lactic acid monomer or from any source that provides an equivalent monomer unit in the thus-formed polymer. Any known polymerization method, such as polycondensation or ring-opening polymerization, may be used to produce such polymers.

A polylactic acid may be an L-lactic acid or D-lactic acid homopolymer; or, it may be a copolymer, such as one that contains L-lactic acid monomer units and D-lactic acid monomer units. (In such polymers, a homopolymer or copolymer designation will be a “stereo” designation based on the tacticity of the monomer units rather than on the chemical composition.) Again, such monomer units may be derived from the incorporation into the copolymer chain of L-lactic acid, D-lactic acid, L-lactide, D-lactide, meso-lactide, and so on. In some embodiments, a polylactic acid may be an L-D copolymer comprised predominately of L-lactic acid monomer units along with a small amount of D-lactic acid monomer units (which may e.g. improve the melt-processability of the polymer). In various embodiments, a polylactic acid copolymer may comprise at least about 85, 90, 95, 96, 97, 98, 99, 99.5, or 99.7 weight % L-lactic acid monomer units. In further embodiments, a polylactic acid copolymer may comprise at most about 15, 10, 5, 4, 3, 2, 1, 0.5, or 0.3 weight % D-lactic acid monomer units.

In some embodiments, substantially all (i.e., 99.5 wt. % or greater) of the polylactic acid content of the meltspun fibers (and/or of the entire polymeric content of the meltspun fibers) may be provided by polylactic acid (stereo) copolymer; e.g. a copolymer comprised predominately of L-lactic acid monomer units along with a small amount of D-lactic acid monomer units. (In specific embodiments, substantially all of the polylactic acid content of the fibers may be in the form of L-lactic acid homopolymer.) In other embodiments, an additional, small amount of polylactic acid consisting of D-lactic acid (stereo) homopolymer may be present. Adding such an additional amount of D-lactic acid homopolymer (e.g. as a physical blend, e.g. as a melt additive during extrusion) may in some cases enhance certain properties (e.g. melt-processability, nucleation rate, and so on) of the polylactic acid materials. Thus in various embodiments, a polylactic acid used e.g. in meltspinning may comprise at least about 0.5, 1, 2, 3, 5, or 8 wt. % of a D-lactic acid homopolymer additive. In further embodiments, such a polylactic acid material may comprise at most about 15, 10, 8, 5, 3, 2, 1, or 0.5 wt. % of a D-lactic acid homopolymer. (In such cases, the balance of the polylactic acid fiber-forming material may be e.g. an L-D stereocopolymer as noted above.)

In some embodiments, at least some polylactic acid that is present in the meltspun fibers may be a (compositional) copolymer that comprises one or more additional (non-lactic acid) monomer units. Such monomer units might include e.g. glycolic acid, hydroxypropionic acid, hydroxybutryic acid, and the like. In various embodiments, lactic acid monomer units (whether L or D, and being derived from whatever source) may make up at least about 80, 85, 90, 95, 97, 99, or 99.5 weight % of the meltspun polylactic acid fibers.

Melt-processable (fiber-forming) polylactic acid polymer materials (e.g., L-D copolymers) are commercially available e.g. from NatureWorks LLC of Minnetonka, MN, under the trade designations INGEO 6100D, 6202D, and 6260D. Melt-processable polylactic acid polymer materials (e.g., D-lactic acid homopolymers) are available e.g. from Synbra Technologies, The Netherlands, under the trade designation SYNTERRA PDLA 1010. Many other potentially suitable polylactic acid materials are also available.

In various embodiments, the polylactic fibers may exhibit a % crystallinity of at least about 20, 30, 40, or 50%. In various embodiments, polylactic acid may make up (in weight percent) at least about 85, 90, 95, 96, 97, 98, 99, or substantially all (i.e., 99.5 or more) or essentially all (i.e., 99.9% or more) of the materials (e.g., the polymeric materials) of the meltspun polylactic acid fibers. In some embodiments, a small amount of non-polylactic acid polymer material may be present in at least some of the meltspun fibers (e.g., added to the polylactic acid as a melt additive in the extrusion process). Some such non-polylactic polymer materials may serve e.g. as polymeric nucleating agents (irrespective of whether e.g. any D-lactic acid homopolymer may be present and may serve a similar purpose, as discussed earlier). In this context a molecular weight of 4000 grams per mole may serve as the dividing line between polymeric and non-polymeric nucleating agents. Any suitable non-polylactic acid polymer may be used as desired, in any suitable amount. In particular embodiments, a polyolefinic material (e.g., polypropylene) may be present in at least some meltspun fibers, at a wt. % of up to about 5, 3, 2, 1, or 0.5. In other embodiments, substantially no (i.e. less than 0.5 wt. %) or essentially no (i.e. less than 0.1 wt. %) polyolefinic material is present in the meltspun polylactic acid fibers.

In some embodiments, a small amount of non-polylactic acid meltspun fibers, or non-meltspun non-polylactic acid fibers (e.g. staple fibers, multicomponent binding fibers, and so on) may be present in the web. In various embodiments, polylactic acid fibers may make up (in weight percent) at least about 85, 90, 95, 96, 97, 98, 99, or substantially all (i.e., 99.5 or more) of the total fibrous material of the web. In such embodiments, any non-polylactic acid fibers may make up less than about 15, 10, 5, 4, 3, 2, 1, 0.5, or 0.1 wt. % of the total fibrous material of the web. Any ancillary material (e.g., non-polymeric additive) may be present in at least some of the meltspun polylactic acid fibers, for any purpose. Such materials may include e.g. one or more antioxidants, UV-stabilizers, processing aids, nucleating agents, antimicrobial agents, pigments, dyes, and so on, present at any (usually, a rather small) amount.

Polylactic acid materials, methods of meltspinning such materials and bonding the resulting fibers to make nonwoven spunbonded fibrous webs, are described in detail in U.S. patent Ser. No. 10/273,612, which is incorporated by reference herein in its entirety. (It is noted that the '612 patent is further concerned with charging such fibers and webs to introduce electret functionality e.g. for enhanced filtration performance, which is not a concern of the present application.)

### Examples

To provide Working Examples, spunbonded nonwoven fibrous webs were obtained, comprised of polylactic acid of the general type available from NatureWorks LLC, Minnetonka, MN, under the trade designation INGEO BIOPOLYMER 6202D. The polylactic acid was not compounded, blended, etc., with any other polymeric material or with any additive. The polylactic acid had been meltspun into fibers according to the general methods and apparatus as outlined earlier herein, and had been autogenously bonded according to the general methods and apparatus as outlined earlier herein. In addition to being autogenously bonded, the webs were point-bonded (after the autogenous bonding), by calendering between a protrusion-bearing calendering roll and a smooth backing roll at appropriate temperature and pressure) to obtain a point-bonded area of approximately 17% of the total web area. Webs were obtained at various basis weights (most of which were approximately 25, 35, 40, or 45 grams per square meter); most such webs were of a porous structure so as to exhibit a loft of approximately 85%. Webs were obtained as wide, continuous rolls and were then cut to the desired size for testing their suitability as containers such as tarps or bags, and for other testing.

Samples of these webs were evaluated in various ways. They were found to exhibit excellent inherent moisture-vapor transmissivity and air-transmissivity (the webs were not perforated), and were found to be compostable, as expected. They were found to exhibit good resistance to water absorption and good resistance to tearing (as evidenced by Elmendorf tear testing), both when dry and after having been water-wetted. The Working Example webs were found to exhibit tensile and breaking strengths that did not drop significantly (e.g., from less than 1%, to approximately 20%) after the webs were water-wetted, in contrast to Comparative Examples of representative cellulosic materials, which exhibited significant drops in tensile and/or breaking strengths (e.g., by a factor of five or more) after being water-wetted. Samples of the Working Example webs exhibited high burst strength e.g. when tested, in a dry state, in the general manner outlined in ASTM Standard D3786M. In particular, the Working Example webs exhibited a burst strength that was generally two or even three times as high as that exhibited by comparative examples in the form of commercially available dense-film (non-porous, non-fibrous, non-cellulosic) compostable materials at similar basis weight.

### Tarps

Tarps and bags formed from the working example webs exhibited very similar properties as the input webs, with very little change resulting from the container-formation processes. For use as tarps, the edges of the nonwoven webs were left unfinished in the manner described earlier herein. The tarps used a single layer of polylactic acid spunbonded fibrous web without any reinforcing layer (e.g. a scrim or netting) or any additional layer of the spunbonded fibrous web being laminated thereto. The webs/tarps were easily foldable to a compacted, generally flat configuration in which the folded tarp occupied less than 10% of the area of the tarp when fully unfolded.

Various thus-produced compostable spunbonded nonwoven fibrous webs were tested for their suitability as yard-waste tarps, with the results being photographically documented. Representative photographs from these Working Examples are presented in FIGS. 3-5. Tarps were produced at a variety of shapes, e.g., from strictly square to somewhat rectangular, and sizes, e.g. from 4 foot×4 foot to 7 foot×7 foot (the tarps in FIGS. 3-5 are approximately 6 foot×6 foot). All of the tarps were used in an unsupported manner (e.g. by being fully unfolded onto the ground) rather than being used in combination with any kind of support frame, holding device, etc.

Knots of the general type discussed herein could be easily tied in the gathered corners of the Working Example tarps. The knotted tarps, filled with compostable material, could be hand-carried by grasping the knots and carrying the loaded, knotted tarps to a desired location. The tarps were found to be fairly translucent to the point that their contents were at least somewhat visible, as evident from FIGS. 4 and 5. It was judged that tarps that were at least generally square, and that were in a size range of approximately 5 foot×5 foot to 6.5 foot by 6.5 foot, represented an optimum combination of capacity, handleability, hand-transportability, and so on, although these must be considered to be preliminary guidelines at this time.

### Bags

Relatively simple bags were formed for testing in bag format. The input webs were single layers of polylactic acid spunbonded fibrous web without any reinforcing layer (e.g. a scrim or netting). The edges of the nonwoven webs were left unfinished in the manner described elsewhere herein. Two sections of such a web were folded along a fold line to form a two-layer stack. The opposing side-edges of the stack were ultrasonically bonded to form a seam. The “top” edge (opposite the fold line) was left unbonded to serve as an opening for the bag. A relatively simple “bag” was thus formed, of a size typical of that used for yard waste.

### Compostability

Working Example samples of such bags (without any compostable material inserted thereinto) were evaluated in several different certified commercial composting facilities. The degradation process was documented via visual inspection and photographic recordation. In every case, the Working Example bags were found to have broken down substantially completely (so that no observable fragments of the bag could be seen via visual inspection) within two weeks. Several Comparative Examples were included in the form of ubiquitous kraft-paper yard-waste bags as available from home-supply stores and hardware stores. After two weeks, upon visual inspection these Comparative Example bags were estimated to still exhibit anywhere from 20 to 85% non-broken-down material.

### Water Egress

Working Example bags were filled with freshly cut grass clippings, in amounts ranging from 30 to 45 pounds. The open ends of the bags were then tied shut. The filled bags were subjected to a water-loss test under real-world conditions in which the bags were placed outdoors (on a driveway) for nine days in June. Over this test period, the daily temperature was mostly in the range of 60-80 degrees F. Approximately one inch of rain fell during the nine-day test period; no attempt was made to shield the bags from the rain. The contents of the bags were not stirred, mixed, or otherwise treated in any such way as to affect the rate of water loss from the bags.

The Working Example bags exhibited approximately 20% weight loss by the end of the second day and approximately 35 to 50% weight loss by the end of the ninth day. (This weight loss is reported as a percentage of total weight, including the nonvolatile (cellulosic) portions of the grass; the percentage weight loss purely in terms of water would have been even higher.)

Two Comparative Examples were included by similarly loading freshly-cut grass clippings (of similar batch size) into two different types of commercially available compostable yard-waste bags. The exact composition of these Comparative Example bags was unknown but they were made of dense-film materials rather than fibrous nonwoven materials. It was believed that the Comparative Example bags were made of polymers such as e.g. polylactic acid and/or polybutylene adipate-co-terephthalate, possibly blended with materials such as processed thermoplastic starches or the like. In any event, the Comparative Example bags were not kraft paper. These Comparative Example bags exhibited approximately 1 to 5% weight loss by the end of the second day and approximately 5 to 15% weight loss by the end of the ninth day. These Comparative Example bags thus enabled far less water loss than the Working Example bags. These Working Example and Comparative Example materials were also subjected to moisture-vapor-transmission-rate (MVTR) laboratory testing; in line with the above results, the Working Example materials exhibited an MVTR (measured in grams/sq m/24 hrs) in the range of 15-20 times that of the Comparative Example materials.

The foregoing Examples have been provided for clarity of understanding only, and no unnecessary limitations are to be understood therefrom. The tests and test results described in the Examples are intended to be illustrative rather than predictive, and variations in the testing procedure can be expected to yield different results. All quantitative values in the Examples are understood to be approximate in view of the commonly known tolerances involved in the procedures used.

It will be apparent to those skilled in the art that the specific exemplary elements, structures, features, details, configurations, etc., that are disclosed herein can be modified and/or combined in numerous embodiments. All such variations and combinations are contemplated by the inventor as being within the bounds of the conceived invention, not merely those representative designs that were chosen to serve as exemplary illustrations. Thus, the scope of the present invention should not be limited to the specific illustrative structures described herein, but rather extends at least to the structures described by the language of the claims, and the equivalents of those structures. Any of the elements that are positively recited in this specification as alternatives may be explicitly included in the claims or excluded from the claims, in any combination as desired. Any of the elements or combinations of elements that are recited in this specification in open-ended language (e.g., comprise and derivatives thereof), are considered to additionally be recited in closed-ended language (e.g., consist and derivatives thereof) and in partially closed-ended language (e.g., consist essentially, and derivatives thereof). To the extent that there is any conflict or discrepancy between this specification as written and the disclosure in any document incorporated by reference herein, this specification as written will control.

What is claimed is:

1. A compostable, air-transmissive, reversible, unsupported tarp configured for use as a container for transporting compostable material, the tarp comprising a compostable, air-transmissive, spunbonded nonwoven fibrous web comprising meltspun fibers that are autogenously melt-bonded and that are additionally melt-bonded by point-bonds that occupy from at least 8% to at most 24% of a total area of the nonwoven fibrous web, the nonwoven fibrous web having unfinished edges and exhibiting a basis weight of from 20 grams per square meter to 100 grams per square meter, and wherein the tarp is at least generally square in shape and is from 25 square feet to 50 square feet in total area when unfolded.

2. The tarp of claim 1 wherein the point-bonds occupy from about 14 to about 20% of the total area of the nonwoven fibrous web.

3. The tarp of claim 1 wherein the tarp is at least substantially square in shape and is from 30 square feet to 40 square feet in total area.

4. The tarp of claim 1 wherein the tarp comprises first and second compostable, complementary joining structures on first and second diagonally-opposing corners of the fibrous nonwoven web.

5. The tarp of claim 1 wherein the tarp consists essentially of the nonwoven fibrous web.

6. The tarp of claim 1 wherein the tarp is packaged in a folded condition in which it exhibits a size that is less than 10% of the total area of the tarp when unfolded.

7. The tarp of claim 1 wherein the nonwoven fibrous web comprises meltspun fibers comprised of materials chosen from the group consisting of polylactide, polybutylene succinate, polybutylene adipate terephthalate, polycaprolactone, polyhydroxyalkanoate, poly-3-hydroxybutyrate, polyhydroxyvalerate, polyhydroxyhexanoate, zein-based materials, cellulosic esters, and mixtures, blends, and copolymers thereof.

8. The tarp of claim 1 wherein the nonwoven fibrous web consists essentially of polylactide fibers.

9. The tarp of claim 1 wherein the tarp comprises a web-usage efficiency factor of at least 90%.

10. A method of using the tarp of claim 1, the method comprising:
placing the tarp on a generally horizontal surface in an unfolded, unsupported condition;
depositing compostable material on an upper major surface of the tarp so that the tarp is loaded with the compostable material;
bringing first and second diagonally-opposing corners of the tarp together, gathering the first and second diagonally-opposing corners, and tying the first and second gathered, diagonally-opposing corners to each other to form a knot that provides a first integral carrying handle for the loaded tarp.

11. The method of claim 10 wherein the method further comprises carrying the loaded tarp by way of the first integral carrying handle, to a pick-up location.

12. The method of claim 10 wherein the tying of the first and second gathered, diagonally-opposing corners to each other comprises tying at least a single overhand knot in the first and second gathered, diagonally-opposing corners.

13. The method of claim 10 wherein the tying of the first and second gathered, diagonally-opposing corners together comprises tying a double overhand knot in the first and second gathered, diagonally-opposing corners.

14. The method of claim 10 wherein the method further comprises bringing third and fourth diagonally-opposing corners of the tarp together, gathering the third and fourth corners, and tying the third and fourth gathered, diagonally-opposing corners to each other to form a second knot that provides a second integral carrying handle for the loaded tarp.

15. The method of claim 14 wherein the tying of the third and fourth gathered, diagonally-opposing corners to each other to form the second integral carrying handle for the loaded tarp comprises tying the third and fourth gathered, diagonally-opposing corners to the first integral carrying handle formed by the tying to each other of the first and second gathered, diagonally-opposing corners.

16. A method of using the tarp of claim 1, the method comprising:
with the tarp at a pick-up location and loaded with compostable material, grasping the tarp by way of a first integral carrying handle comprising first and second diagonally-opposing, gathered, tied-together corners of the nonwoven fibrous web, and depositing the loaded tarp into a collection vehicle;
transporting the loaded tarp to a composting facility;
and,
unloading the loaded tarp from the collection vehicle and introducing the loaded tarp into a composting batch at the composting facility.

17. The method of claim 16 wherein the tarp further comprises a second integral carrying handle comprising third and fourth diagonally-opposing, gathered, tied-together corners of the nonwoven fibrous web.

18. A kit comprising at least two of the tarps of claim 1, each tarp being folded to a size that is less than 10% of the unfolded, total area of the tarp, with the folded tarps being arranged as a stack in a common package.

19. A method of using the kit of claim 18, the method comprising:
removing a folded tarp from the common package;
unfolding the tarp and placing the tarp on a generally horizontal surface in an unfolded, unsupported condition;
depositing compostable material on an upper surface of the tarp so that the tarp is loaded with the compostable material; and
bringing at least first and second diagonally-opposing corners of the tarp together, gathering the first and second diagonally-opposing corners, and tying the first and second gathered, diagonally-opposing corners to each other to form a first integral carrying handle for the loaded tarp.

20. A compostable, air-transmissive container for transporting compostable material, the container comprising a compostable, air-transmissive, spunbonded nonwoven fibrous web comprising meltspun fibers that are autogenously melt-bonded and that are additionally melt-bonded by point-bonds that occupy from at least 8% to at most 24% of a total area of the nonwoven fibrous web.

21. A method of using the container of claim 20, the method comprising depositing compostable material into the container.
